(19) United States
(12) Patent Application Publication
(10) Pub. No.: US 2025/0335492 A1
(43) Pub. Date: Oct. 30, 2025

(54) COMPUTING SYSTEMS AND METHODS FOR MULTI-LABEL CONFORMAL PREDICTION FOR RETRIEVAL AUGMENTED GENERATION

(71) Applicant: The Toronto-Dominion Bank, Toronto (CA)

(72) Inventors: Noël VOUITSIS, Markham (CA); Maksims VOLKOVS, Toronto (CA); Jesse Cole CRESSWELL, Toronto (CA); Yi SUI, Toronto (CA); Graham Andrew WARNER, Victoria (CA); Jiapeng WU, Toronto (CA)

(21) Appl. No.: 18/651,063

(22) Filed: Apr. 30, 2024

(51) Int. Cl. G06F 16/383; G06F 16/33; G06F 16/338

(52) U.S. Cl. CPC G06F 16/383; G06F 16/3334; G06F 16/338

(57) ABSTRACT

Systems and methods for retrieving relevant documents. A computing system obtains, from each document in a corpus of documents, a plurality of chunks corresponding to portions of text. It computes a score for each one of the plurality of chunks in relation to a query. The chunks are reordered according to score. A sum of the highest scores is computed, and a subset of chunks associated with the highest scoring documents are retrieved. A large language model (LLM) may be used to generate response text from the retrieved documents.

### TECHNICAL FIELD

The disclosed exemplary embodiments relate to computer-implemented systems and methods for multi-label conformal prediction for retrieval augmented generation.

### BACKGROUND

In a retrieval augmented generation (RAG) system, external knowledge is used to enhance inputs into a large language model (LLM) for generating a response to a query. In some cases, it is desirable to retrieve relevant information from a large corpus of documents and use that relevant information (which may be external knowledge) to inform the LLM when generating the response. The RAG system includes a retriever that retrieves the relevant information.

### SUMMARY

The following summary is intended to introduce the reader to various aspects of the detailed description, but not to define or delimit any invention.

In at least one broad aspect, a system for retrieving documents is provided. The system comprises: a memory, a communication interface, and a processor operatively coupled to the memory and the communication interface. The processor is configured to: from each document in a set of documents, obtain a plurality of chunks corresponding to portions of text; compute a score for each one of the plurality of chunks in relation to a query; generate a reordered set of chunks that is ordered from a highest score associated with a first given chunk in the reordered set of chunks to a lowest score associated with a last given chunk in the reordered set of chunks; compute a sum of n number of highest scores, wherein the sum is at least equal to a threshold, and produce a subset of chunks that are associated with the n number of highest scores; identify one or more documents, which are associated with the subset of chunks, as relevant to the query, wherein the one or more documents are a subset of the set of documents; and, retrieve the one or more documents.

In some cases, multiple documents are associated with the subset of chunks, and the multiple documents are retrieved.

In some cases, the subset of chunks and the n number of highest scores are stored in association with the one or more documents.

In some cases, the system further comprises a document repository storing the set of documents in the memory, a retriever module in the memory, and a generator large language model (LLM) in the memory. The processor is further configured to: obtain, using the retriever module, the query or a representation of the query; retrieve, using retriever module, the one or more documents, which are labelled as relevant to the query, from the document repository; and generate, using the generator LLM, a response that comprises text from the one or more documents.

In some cases, the retriever module and the generator LLM ignore one or more remaining documents from the set of documents that have been identified as insufficiently relevant to the query.

In some cases, the subset of chunks that correspond to the one or more documents are multi-label conformalized prediction sets.

In some cases, a reranker scoring computation is used to compute the score for each one of the plurality of chunks in relation to the query.

In some cases, a relevance scoring computation is used to compute the score for each one of the plurality of chunks in relation to the query.

In some cases, a plurality of chunks is represented as a plurality of embeddings.

In some cases, the system further comprises a vector database and an embeddings LLM. The embeddings LLM produces the plurality of embeddings from the plurality of chunks that correspond to portions of text in each document, and the vector database stores the plurality of embeddings.

In at least another broad aspect, a method is provided for retrieving documents. The method is executed in a computing environment comprising one or more processors, a communication interface, and memory, and the method comprises: from each document in a set of documents, obtaining a plurality of chunks corresponding to portions of text; computing a score for each one of the plurality of chunks in relation to a query; generating a reordered set of chunks that is ordered from a highest score associated with a first given chunk in the reordered set of chunks to a lowest score associated with a last given chunk in the reordered set of chunks; computing a sum of n number of highest scores, wherein the sum is at least equal to a threshold, and produce a subset of chunks that are associated with the n number of highest scores; identifying one or more documents, which are associated with the subset of chunks, as relevant to the query, wherein the one or more documents are a subset of the set of documents; and, retrieving the one or more documents.

In some cases, multiple documents are associated with the subset of chunks and are identified as relevant to the query, and the multiple documents are retrieved.

In some cases, the subset of chunks and the n number of highest scores are stored in association with the one or more documents.

In some cases, the memory comprises: a document repository storing the set of documents, a retriever module, and a generator LLM. The method further comprises: obtaining, using the retriever module, the query or a representation of the query; retrieving, using retriever module, the one or more documents, which are labelled as relevant to the query, from the document repository; and generating, using the generator LLM, a response that comprises text from the one or more documents.

In some cases, the retriever module and the generator LLM ignore one or more remaining documents from the set of documents that have been identified as insufficiently relevant to the query.

In some cases, the subset of chunks that correspond to the one or more documents are multi-label conformalized prediction sets.

In some cases, a reranker scoring computation is used to compute the score for each one of the plurality of chunks in relation to the query.

In some cases, a relevance scoring computation is used to compute the score for each one of the plurality of chunks in relation to the query.

In some cases, the memory comprises a vector database and an embeddings LLM; wherein the embeddings LLM produces the plurality of embeddings from the plurality of chunks that correspond to portions of text in each document; and the vector database stores the plurality of embeddings.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1A is a schematic block diagram of a system for processing documents in accordance with at least some embodiments;

FIG. 1B is a schematic block diagram of a cloud-based computing cluster of FIG. 1A, including a pipeline configured for a RAG system and further configured for multi-label conformal prediction, in accordance with at least some embodiments;

FIG. 2 is a block diagram of a computer in accordance with at least some embodiments;

FIG. 3 is a schematic block diagram of a process for multi-label conformal prediction of multiple documents for retrieval in a RAG system, showing example data components, in accordance with at least some embodiments;

FIG. 4 is a schematic block diagram of a process for conformal prediction of a single document for retrieval in a RAG system, showing example data components, in accordance with at least some embodiments;

FIG. 5 is a flowchart diagram of an example method of retrieving documents using multi-label conformal prediction, in accordance with at least some embodiments; and

FIG. 6 is a flowchart diagram of another example method of receiving a query, retrieving documents, and using the retrieved documents and the query to output a response to the query, in accordance with at least some embodiments.

### DETAILED DESCRIPTION

A computing system is provided that computes multi-label conformalized prediction sets that are inputted into a RAG process. In some cases, this this is applied to obtaining one or multiple documents that are applicable to a given query.

In many cases, it is customary to feed a LLM a set of top-k retrieved chunks from documents returned by the retriever to generate a response to a query. However, fixing k in this setting does not provide flexibility for the retriever to communicate its uncertainty about the query. In some cases, the retriever will return k passages even if it is very certain the answer is contained in a smaller subset. This can provide superfluous and even wrong information to a downstream LLM which is not inherently robust to irrelevant context, causing it to possibly generate a wrong response or hallucinate. In some other cases, returning k passages means that if the retriever is uncertain and wishes to return more than k passages, it is unable to do so in a standard RAG system. In many RAG systems, the lack of uncertainty quantification is pervasive.

Conformal prediction is a method for taking heuristic notions of uncertainty (e.g., raw search scores from the retriever) and converting them into a statistically rigorous notion of uncertainty in the form of output sets. In some cases, instead of outputting a fixed number of predictions in top-k, a conformal prediction computation outputs a set of likely options depending on the model's uncertainty about a particular input with larger sets implying more uncertainty. In some cases, the conformal prediction computation outputs the true label(s) that will lie in the output set with a fixed probability of at least 1-α, where a can be thought of as the error rate. In some cases, in a RAG system provided herein, conformal prediction is modified for multi-label and applied to the RAG system, since a response to a query can be enhanced using multiple documents.

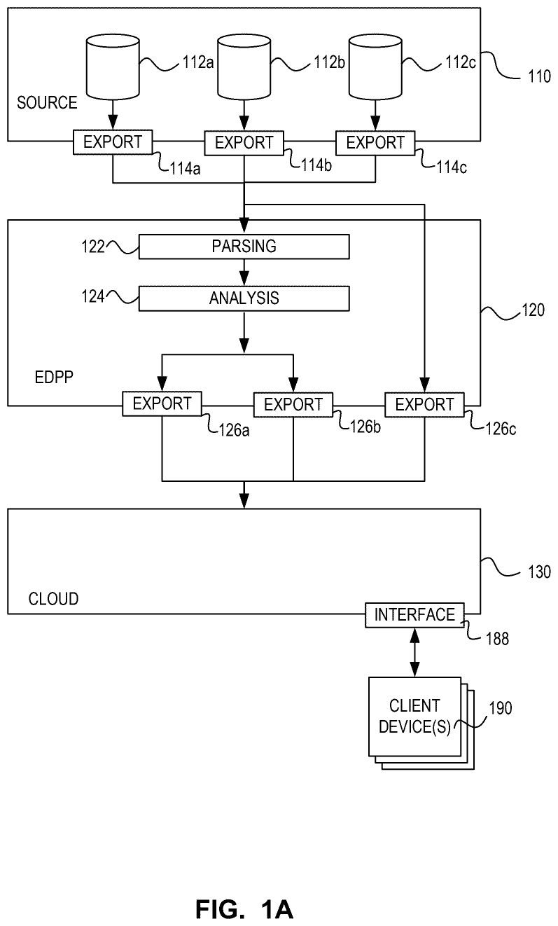

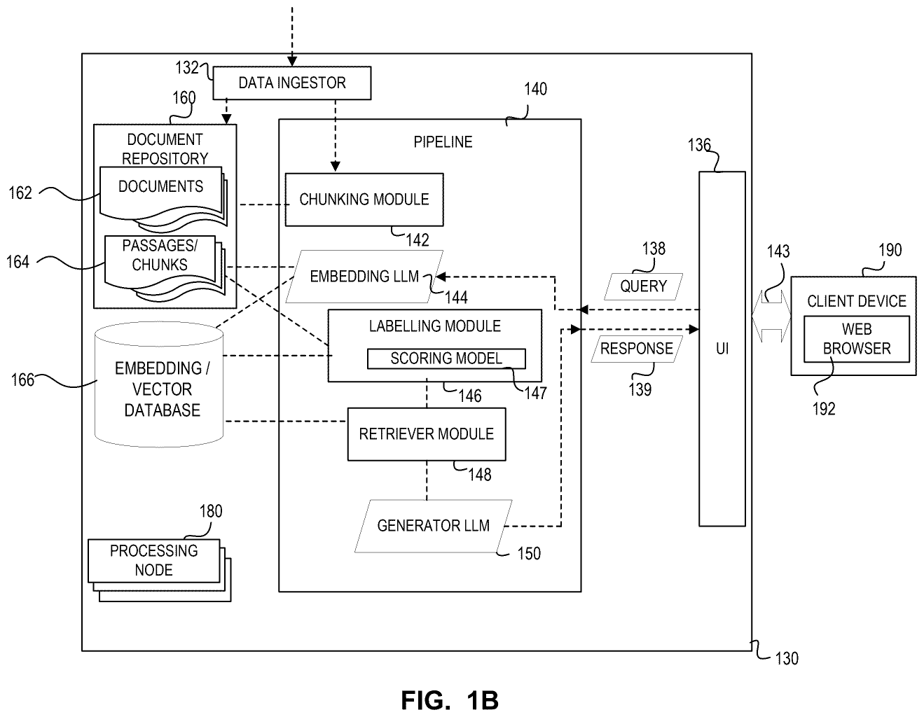

Referring now to FIG. 1A, there is illustrated a block diagram of an example computing system, in accordance with at least some embodiments. Computing system 100 has a source database system 110, an enterprise data provisioning platform (EDPP) 120 operatively coupled to the source database system 110, and a cloud-based computing cluster 130 that is operatively coupled to the EDPP 120. In some cases. this computing system 100 is provided for automated data processing of large data sets, including identify relevant documents to automatically generate responses in relation to a given query. In some cases, the documents are files that include text. In some cases, different data formats of documents or files (or both), and which include text, can be used in the computing system described herein.

Source database system 110 has one or more databases, of which three are shown for illustrative purposes: database 112a, database 112b and database 112c. One or more the databases of the source database system 110 may contain confidential information that is subject to restrictions on export. One or more export modules 114a, 114b, 114c may periodically (e.g., daily, weekly, monthly, etc.) export data from the databases 112a, 112b, 112c to EDPP 120. In some instances, the data is exported on an ad hoc basis.

EDPP 120 receives source data exported by the export modules 114 of source database system 110, processes it and exports the processed data to an application database within the cloud-based computing cluster 130. For example, a parsing module 122 of EDPP 120 may perform extract, transform and load (ETL) operations on the received source data.

In many environments, access to the EDPP may be restricted to relatively few users, such as administrative users. However, with appropriate access permissions, data relevant to a document or group of documents (e.g., a client document) may be exported via reporting and analysis module 124 or an export module 126. In particular, parsed data can then be processed and transmitted to the cloud-based computing cluster 130 by a reporting and analysis module 124. Alternatively, one or more export modules 126a, 126b, 126c can export the parsed data to the cloud-based computing cluster 130.

In some cases, there may be confidentiality and privacy restrictions imposed by governmental, regulatory, or other entities on the use or distribution of the source data. These restrictions may prohibit confidential data from being transmitted to computing systems that are not “on-premises” or within the exclusive control of an organization, for example, or that are shared among multiple organizations, as is common in a cloud-based environment. In particular, such privacy restrictions may prohibit the confidential data from being transmitted to distributed or cloud-based computing systems, where it can be processed by machine learning systems, without appropriate anonymization or obfuscation of personal identifiable information (PII) in the confidential data. Moreover, such “on-premises” systems typically are designed with access controls to limit access to the data, and thus may not be resourced or otherwise suitable for use in broader dissemination of the data. In some cases, to comply with such restrictions, one or more module of EDPP 120 may “de-risk” data tables that contain confidential data prior to transmission to cloud-based computing cluster 130. In some cases, this de-risking process may obfuscate or mask elements of confidential data, or may exclude certain elements, depending on the specific restrictions applicable to the confidential data. The specific type of obfuscation, masking or other processing is referred to as a “data treatment.”

The cloud-based computing cluster 130 includes an interface 188, which facilitates data communication with one or more client devices.

In some environments, the EDPP may be omitted.

Referring now to FIG. 1B, there is illustrated a block diagram of the cloud-based computing cluster 130, showing greater detail of the elements of the cloud-based computing cluster, which may be implemented by computing nodes of the cluster that are operatively coupled.

The components of the cloud-based computing cluster 130 include a data ingestor 132, a pipeline 140, a user interface (UI) 136 for the pipeline 140, a document repository 160, and a vector database 166, which in some cases are implemented as one or more processing nodes 180 in the cloud-based computing cluster. In some cases, these components are implemented as virtual machines within the cloud-based computing cluster.

In some cases, the pipeline 140 is configured for a RAG system and is further configured for multi-label conformal prediction. In some cases, the pipeline 140 includes a chunking module 142, an embedding LLM 144, a labelling module 146, a retriever module 148, and a generator LLM. The pipeline 140, for example, is a computing system.

In some cases, the chunking module 142 obtains multiple documents 162 through a document loader, which may be part of or in addition to a data ingestor 132. In some cases, for each given document, the chunking module 142 segments the text in the given document into portions of text. In some cases, semantic chunking is used to segment the text. In some other cases, document-based chunking is used to segment the text, which identifies and uses a structure of a document. Other examples of chunking computations include recursive chunking and fixed-sized chunking. Other currently known and future known chunking computations can be used by the chunking module 142.

In some cases, the embedding LLM 144 encodes the chunks into embeddings (also called vectors) and stores and indexes the embeddings into a vector database 166. In some other cases, the embeddings are stored in a graph database, either in alternative or in addition to the vector database 166.

In some cases, a chunk corresponds to a portion of text in a given document. The chunk is represented as an embedding.

In some cases, the labelling module 146 is configured to compute a multi-label conformal prediction set that includes a set of one or multiple documents that are relevant to a given query. In some cases, the labelling module 146 includes a scoring module 147 that scores the relevance of text in a chunk with respect to a given query.

In some cases, the retriever module 148 is configured to retrieve the one or more documents labelled as relevant to the given query. In some cases, the retriever module 148 ignores other documents in the set of available documents (e.g., the document set). In this way, the retriever module 148 does not need to process documents that are considered superfluous, which could cause hallucinations. In some cases, the retriever module 148 uses a standard retriever computation, or a sentence window computation, or an auto-merging computation. In some other cases, other currently known or future known computations are used that are configured to retrieve documents, or a portion of a document, as part of the pipeline 140 for RAG.

In some cases, the functions of the labelling module 146 and the retriever module 148 are combined together, and the combined module is referred to as a retriever module or as a modified retriever module.

In some cases, a generator LLM 150 is configured to generate responses to a given query. The generator LLM 150 is configured to synthesize the retrieved information (e.g., provided by the retriever module 148) with its pre-trained configuration to generate a contextually relevant response.

In some cases, text data (e.g., in the form of documents or other files) are obtained via the data ingestor 132 and are transmitted into the chunking module 142 or the document repository 160, or both. The chunking module 142 generates chunks 164 from the multiple documents, which are processed by the embedding LLM 144 to generate embeddings that are stored in the vector database 166, or a graph database, or both. A user interface 136 provides a query 138 (e.g., which may be text) to the embedding LLM 144, which processes the query 138 to generate a vector representation of the query. The vector representation of the query is also herein referred to as “query”. In some cases, the vector representation of the query is used for computations in the pipeline 140. The labelling module 146 identifies and labels one or more documents that are considered relevant to the query. The one or more documents, or identities of the one or more documents, are transmitted to the retriever module 148. The retriever module 148 uses the query and searches for, and outputs, relevant information obtained from only the one or more documents. In some cases, the remaining documents, which have been by default identified as insufficiently relevant, are ignored by the retriever module 148. The retriever module 148, or another module in the pipeline 140, transmits relevant information for enhanced context to the generator LLM 150. In some cases, an expanded prompt is generated using the relevant information outputted by the retriever module 148 and the query. In some cases, the expanded prompt is a vector representation. The expanded prompt is inputted into the generator LLM 150, and the generator LLM 150 outputs a response 139. The response 139 is provided to the user interface 136. In some cases, the response 139 provided to the user interface 136 is a text response, which includes contextually relevant information from the one or more documents identified by the labelling module 147.

In some cases, the computations by the pipeline 140 includes obtaining k chunks in a search index, such as the vector database 166, and executing a computation f(q,p) that returns a search score between a query q and a chunk p. In some cases, the computation f(q,p) is executed by the retriever module 148. It is assumed also that for each query q there is a required set of documents D. The expression π(q) is the permutation of {1, . . . ,k} that sorts results of f(q,p) from a highest search score to a lowest search score for each of the k chunks p in the search index. A conformal score function is computed as the sum of the sorted search scores until a desired document-level recall is reached as

$$s ( q , D ) = {\sum }_{j = 1}^{k} f ( q , {p}_{{π}_{j} ( q )} )$$

$$where$$

$$k = {sup}_{d ∈ D} inf \{ t : {p}_{{π}_{t} ( q )} ∈ d \} .$$

After, as part of the conformal prediction computation, the quantile value

$${q}^{′} = Quantil e ( {s}_{1} , … , {s}_{n} ; \frac{⌈ ( n + 1 ) ( 1 - α ) ⌉}{n} ) ,$$

using a calibration set of size n. Multi-label conformalized prediction sets for RAG can then be constructed, while avoiding zero-sized sets. The multi-label conformalized prediction sets are constructed as

$${𝒞 ( q )}_{=} \{ {π}_{1} ( q ) , … , {π}_{k} ( q ) \}$$

$$where$$

$$k = sup \{ {k}^{′} : {\sum }_{j = 1}^{{k}^{′}} f ( q , {p}_{{π}_{j} ( q )} ) < \hat{q} \} + 1.$$

In some cases, the conformal prediction computation outputs the true label(s) that will lie in the output set with a fixed probability of at least 1-α. In some cases where the desired error α is 5%, then the desired fixed probability is 95%. It will be appreciated that other values of the fixed probability can be used.

In some cases, the query 138 is provided by a client device 190 that connects over a data communication link 143 to the user interface 136. For example, a user inputs a query 138 via a web browser 192 or some other application that operates on the client device 190. The user interface 136 receives the response 139 and transmits the response to the client device 190, which can be presented to the user of the client device 190.

It will be appreciated that, while the components shown in FIG. 1B for the cloud-based computing cluster 130 can be implemented with the system 100 in FIG. 1A, in some other cases, the components shown in FIG. 1B are instead implemented in an isolated computing server system. In other words, the components shown in FIG. 1B can be implemented as a processing node 180 without the EDPP 120 and the source database system 110.

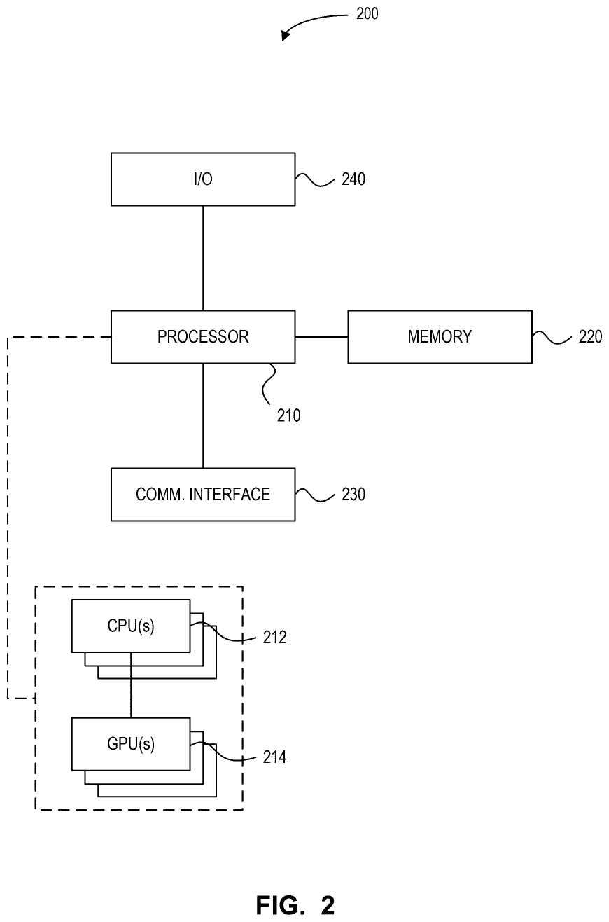

Referring now to FIG. 2, there is illustrated a simplified block diagram of a computer 200 in accordance with at least some embodiments. The computer 200 is also herein interchangeably called a computing system. Computer 200 is an example implementation of a computer such as source database system 110, EDPP 120, processing node 180 of FIGS. 1A and 1B. Computer 200 has at least one processor 210 operatively coupled to at least one memory 220, at least one communications interface 230 (also herein called a network interface), and at least one input/output device 240.

The at least one memory 220 includes a volatile memory that stores instructions executed or executable by processor 210, and input and output data used or generated during execution of the instructions. Memory 220 may also include non-volatile memory used to store input and/or output data—e.g., within a database—along with program code containing executable instructions.

Processor 210 may transmit or receive data via communications interface 230, and may also transmit or receive data via any additional input/output device 240 as appropriate.

In some cases, the processor 210 includes a system of central processing units (CPUs) 212. In some other cases, the processor includes a system of one or more CPUs and one or more Graphical Processing Units (GPUs) 214 that are coupled together. For example, the secondary LLM 170 executes neural network computations on CPU and GPU hardware, such as the system of CPUs 212 and GPUs 214.

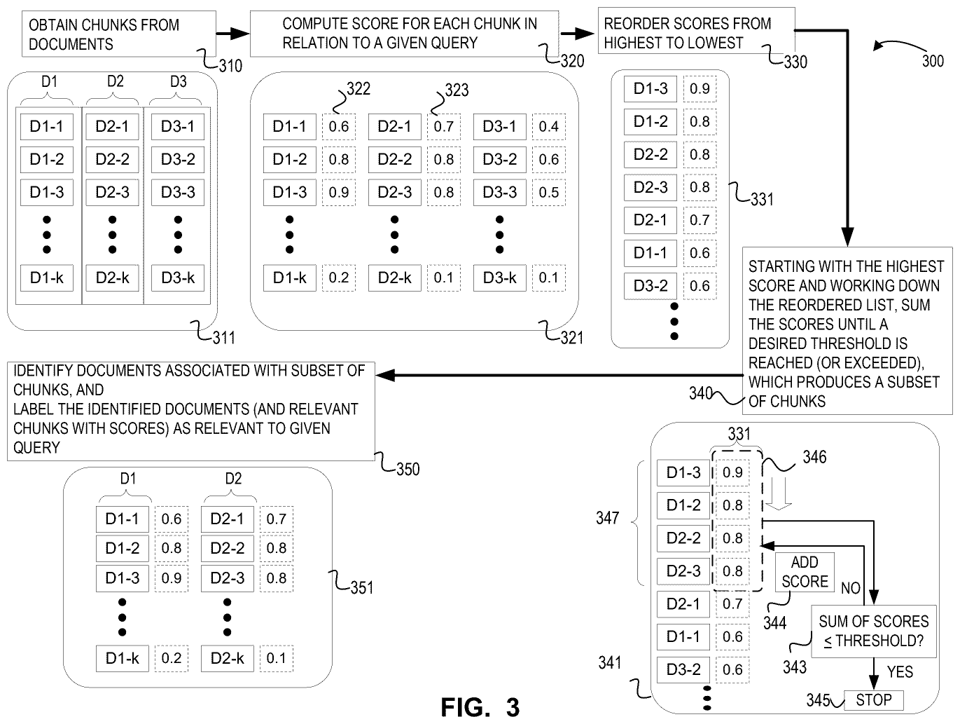

Referring now to FIG. 3, an example embodiment of a multi-label conformal prediction process 300 is provided, which in some cases is executed by the labelling module 146, or more generally by a computing system.

Block 310: A computing system obtains chunks from a set of documents.

In an example illustration of documents 311, there are multiple documents D1, D2 and D3 in the set. The chunks for document D1 are labelled in FIG. 3 as D1-1, D1-2, D1-3, . . . , D1-k. The chunks for document D2 are labelled as D2-1, D2-2, D2-3, . . . , D2-k. The chunks for document D3 are labelled as D3-1, D3-2, D3-3, . . . , D3-k.

Block 320: The computing system computes a score for each chunk in relation to a given query.

In some cases, a reranker scoring computation is used to compute the score for each one of the plurality of chunks in relation to the query. In some other cases, a relevance scoring computation is used to compute the score for each one of the plurality of chunks in relation to the query.

In an example illustration of scoring values 321, a score 322 is computed in relation to the chunk D1-1, a score 323 is computed in relation to the chunk D2-1, and so forth. It will be appreciated that the scores are numerical values. In the example illustration of scoring values 321, a higher score indicates that a given chunk is more relevant to the given query. For example, the chunk D1-1 has a score of 0.6 and the chunk D1-2 has a score of 0.8, which means that the chunk D1-2 is more relevant to the given query than chunk D1-1.

Block 330: The computing system reorders all the scores from all the chunks in the set of documents from highest to lowest. In other words, the computing system generates a reordered set of chunks that is ordered from a highest score associated with a first given chunk in the reordered set of chunks to a lowest score associated with a last given chunk in the reordered set of chunks.

An example illustration of a reordered set of chunks 331 is shown in FIG. 3, which is based on the associated scores. In this example, the chunk D1-3 is ordered first and has a score of 0.9, which the highest score; the chunk D1-2 is ordered second and has a score of 0.8, which is the second highest; and so forth as shown in FIG. 3.

Block 340: Starting with the highest score and working down the reordered list of chunks, the computing system computes a sum of the scores until a desired threshold is reached (or exceeded). This produces a subset of chunks from amongst the reordered set of chunks.

In other words, the computing system computes a sum of n number of highest scores, wherein the sum is at least equal to a threshold, and the computing system produces a subset of chunks that are associated with the n number of highest scores.

In an example illustration of obtaining the sum 341, the n number of highest scores 346 is summed until a threshold is reached. In some cases, a loop condition 343 determines if a sum of the highest score is equal to or greater than a threshold value, and if not, then another score that is the next highest on the reordered list of chunks 331 is added (block 344). This loop continues until the loop condition 343 indicates that the sum of the scores has reached or exceeded the threshold. In an example embodiment, the loop condition further includes that the sum of scores produces a desired quantile value, which is more generally called a threshold. In some cases, the conformal prediction computation outputs the true label(s) (which correspond to chunks) that will lie in the output set that produces the desired quantile value. In other words, the subset of chunks that correspond to the one or more documents are multi-label conformalized prediction sets.

Block 350: The computing system identifies documents associated with the subset of chunks, and labels the identified documents as relevant to the given query. In some cases, the relevant chunks with scores are also labeled and identified as relevant to the given query.

In the example illustration of obtaining the sum 341, the documents 347 are associated with the subset of chunks 331. In an example illustration of the labeled documents 351, the documents D1 and D2 (and in some case their respective chunks and scores) are retrieved by the retriever module 348. In some cases, this retrieved information, along with the query 138, is sent to the generator LLM 150 to compute a response.

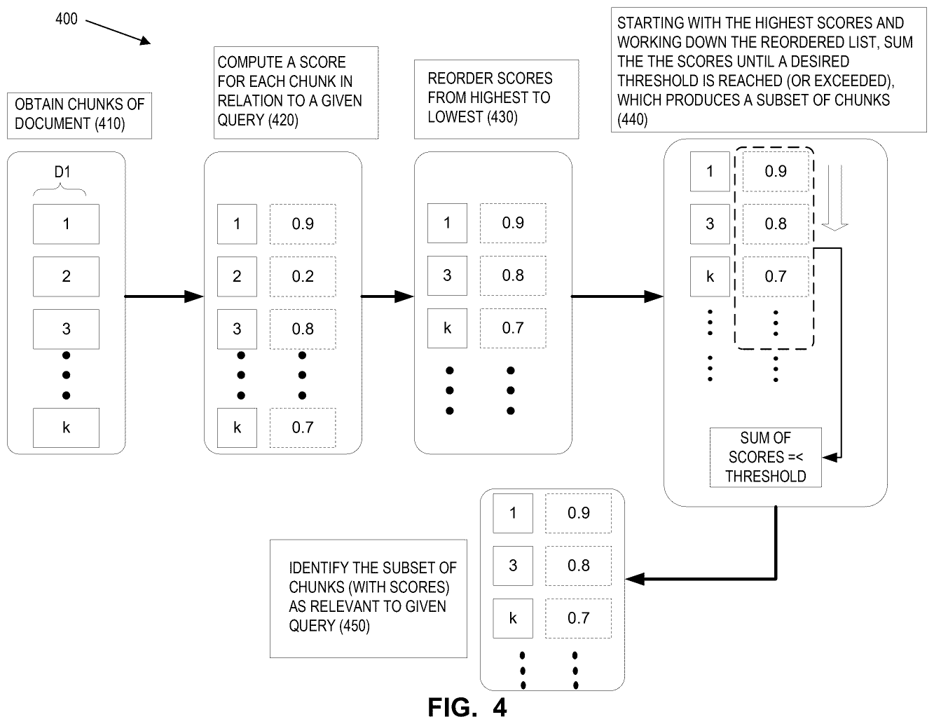

Referring to FIG. 4, another example process 400 is shown that is similar to the process shown in FIG. 3, but is for a single document D1. The most conformal prediction sets for a single document is computed.
Block 410: The computing system obtains chunks of a document.
Block 420: The computing system computes a score for each chunk in relation to a given query.
Block 430: The computing system reorders the scores from highest to lowest, generating a reordered list.
Block 440: The computing system, starting with the highest scores working down the reordered list, sums the scores until a threshold is reached or exceeded. This produces a subset of chunks that are associated with the set of highest scores, in which their sum has reached or exceeded the threshold.
Block 450: The computing system identifies the subset of chunks as relevant to the given query.

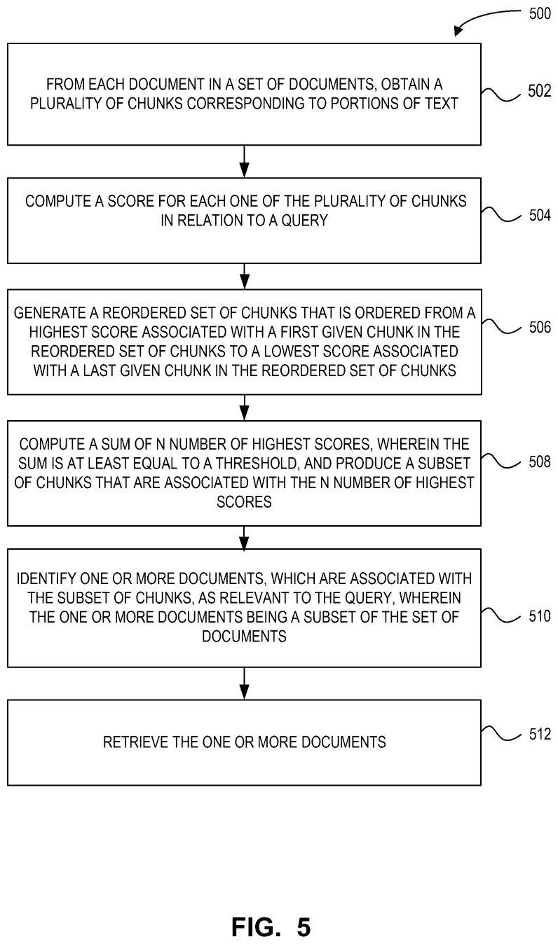

Referring now to FIG. 5, an example flow diagram shows a process 500 of executable operations used to retrieve one or more documents.
Block 502: From each document in a set of documents, the computing system obtains a plurality of chunks corresponding to portions of text.
Block 504: The computing system computes a score for each one of the plurality of chunks in relation to a query.
Block 506: The computing system generates a reordered set of chunks that is ordered from a highest score associated with a first given chunk in the reordered set of chunks to a lowest score associated with a last given chunk in the reordered set of chunks.
Block 508: The computing system computes a sum of n number of highest scores, wherein the sum is at least equal to a threshold. The computing system then produces a subset of chunks that are associated with the n number of highest scores. In some cases, the number n is a natural number.
Block 510: The computing system identifies one or more documents, which are associated with the subset of chunks, as relevant to the query, wherein the one or more documents being a subset of the set of documents.
Block 512: The computing system retrieves the one or more documents.

In some cases in the process 500, by applying multi-label conformal prediction to the RAG computations, the computing system is able to calibrate raw search scores into a statistically rigorous notion of uncertainty. In turn, the computing system is able to identify a smaller set of documents with a higher certainty level of prediction. This is contrast to, in some cases, existing RAG computations that identify a larger set of documents with a lower certainty level of prediction, and which in some cases are more prone to hallucinations and providing wrong responses.

In some cases, the process 500 also reduces the number of documents needed for retrieval and processing by the generator LLM 150, which reduces the computational burden on the computing system.

In some cases, the remaining documents in the set of documents that were not considered relevant, are by default considered insufficiently relevant. In some cases, the retriever module 148 or the generator LLM 150, or both, ignore these documents that are identified as insufficiently relevant, which reduces the computational burden on the computing system.

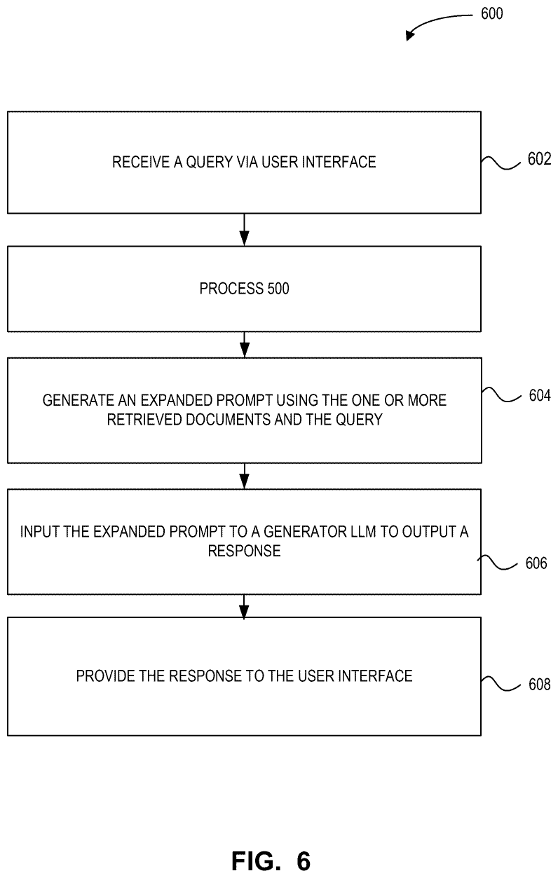

Referring now to FIG. 6, an example flow diagram shows a process 600 of executable operations used to retrieve one or more documents in the context of a user interface 136 that provides a query and receives a response.
Block 602: The computing system receives a query via a user interface.
Process 500: The computing system executes the process 500 as described with respect to FIG. 5.
Block 604: The computing system generates an expanded prompt using the one or more retrieved documents (e.g., from block 512) and the query.
Block 606: The computing system inputs the expanded prompt into a generator LLM, which outputs a response. In some cases, the response comprises text from the one or more documents.
Block 608: The computing system provides the response to the user interface.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g., 112a, or 112b). All elements with a common base number may be referred to collectively or generically using the base number without a suffix (e.g., 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g. a pushbutton keyboard, mouse, a touchscreen, and the like), and at least one output device (e.g. a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

1. A system for retrieving documents, the system comprising:
a memory, a communication interface, and a processor operatively coupled to
the memory and the communication interface;
the processor configured to execute a pipeline, the pipeline comprising:
a chunking module configured to obtain a plurality of chunks in an initial order corresponding to portions of text from each document in a set of documents;
a scoring module configured to compute a score for each one of the plurality of chunks in relation to a query;
a labelling module configured to generate a reordered set of chunks that is ordered from a highest score associated with a first given chunk in the reordered set of chunks to a lowest score associated with a last given chunk in the reordered set of chunks;
the labelling module configured to compute a sum of n number of highest scores from the reordered set of chunks, wherein the sum is at least equal to a threshold, and produce a subset of chunks that are associated with the n number of highest scores;
the labelling module configured to identify one or more documents, which are associated with the subset of chunks, as relevant to the query, wherein the one or more documents are a subset of the set of documents;
a retriever module configured to retrieve the one or more documents from a document repository and ignore a remaining set documents of the set of documents; and,
a generator large language model (LLM) configured to generate and output a response to the query that comprises text from the one or more documents.

2. The system of claim 1, wherein multiple documents are associated with the subset of chunks and are identified as relevant to the query, and the multiple documents are retrieved.

3. The system of claim 1, wherein the subset of chunks and the n number of highest scores are stored in association with the one or more documents.

4. The system of claim 1, further comprising a data ingestor that transmits the set of documents to the chunking module and the document repository.

5. The system of claim 1, wherein computing the sum of n number of highest scores comprises determining if the highest score is equal to or greater than the threshold and, if not, then adding a next highest score in the reordered set of chunks according to a loop condition, until the sum of n number of highest scores is at least equal to the threshold.

6. The system of claim 1, wherein the subset of chunks that correspond to the one or more documents are multi-label conformalized prediction sets.

7. The system of claim 1, wherein a reranker scoring computation is used to compute the score for each one of the plurality of chunks in relation to the query.

8. The system of claim 1, wherein a relevance scoring computation is used to compute the score for each one of the plurality of chunks in relation to the query.

9. The system of claim 1, wherein the plurality of chunks is represented as a plurality of embeddings.

10. The system of claim 1, further comprising a vector database and an embeddings large language model (LLM); wherein the embeddings LLM produces a plurality of embeddings from the plurality of chunks that correspond to portions of text in each document; and the vector database stores the plurality of embeddings.

11. A method for retrieving documents, the method executed in a computing environment comprising one or more processors, a communication interface, and memory, and the method comprising:
providing a pipeline comprising a chunking module, a scoring module, a labelling module, a retriever module, and a generator large language model (LLM);
obtaining, using the chunking module, a plurality of chunks in an initial order corresponding to portions of text from each document in a set of documents;
computing, using the labelling module, a score for each one of the plurality of chunks in relation to a query;
generating, using the labelling module, a reordered set of chunks that is ordered from a highest score associated with a first given chunk in the reordered set of chunks to a lowest score associated with a last given chunk in the reordered set of chunks;
computing, using the labelling module, a sum of n number of highest scores from the reordered set of chunks, wherein the sum is at least equal to a threshold, and produce a subset of chunks that are associated with the n number of highest scores;
identifying, using the labelling module, one or more documents, which are associated with the subset of chunks, as relevant to the query, wherein the one or more documents being a subset of the set of documents; and
retrieving, using the retriever module, the one or more documents from a document repository and ignoring a remaining set of documents of the set of documents; and,
generating and outputting, using the generator LLM, a response to the query that comprises text from the one or more documents.

12. The method of claim 11, wherein multiple documents are associated with the subset of chunks and are identified as relevant to the query, and the multiple documents are retrieved.

13. The method of claim 11, wherein the subset of chunks and the n number of highest scores are stored in association with the one or more documents.

14. The method of claim 11, further comprising a data ingestor transmitting the set of documents to the chunking module and the document repository.

15. The method of claim 11, wherein computing the sum of n number of highest scores comprises determining if the highest score is equal to or greater than the threshold and, if not, then adding a next highest score in the reordered set of chunks according to a loop condition, until the sum of n number of highest scores is at least equal to the threshold.

16. The method of claim 11, wherein the subset of chunks that correspond to the one or more documents are multi-label conformalized prediction sets.

17. The method of claim 11, wherein a reranker scoring computation is used to compute the score for each one of the plurality of chunks in relation to the query.

18. The method of claim 11, wherein a relevance scoring computation is used to compute the score for each one of the plurality of chunks in relation to the query.

19. The method of claim 11, wherein the memory comprises a vector database and an embeddings large language model (LLM); wherein the embeddings LLM produces a plurality of embeddings from the plurality of chunks that correspond to portions of text in each document; and the vector database stores the plurality of embeddings.

20. A non-transitory computer readable medium storing computer executable instructions which, when executed by at least one computer processor, cause the at least one computer processor to carry out a method for retrieving documents, the method comprising:
providing a pipeline comprising a chunking module, a scoring module, a labelling module, a retriever module, and a generator large language model (LLM);
obtaining, using the chunking module, a plurality of chunks in an initial order corresponding to portions of text from each document in a set of documents;
computing, using the labelling module, a score for each one of the plurality of chunks in relation to a query;
generating, using the labelling module, a reordered set of chunks that is ordered from a highest score associated with a first given chunk in the reordered set of chunks to a lowest score associated with a last given chunk in the reordered set of chunks;
computing, using the labelling module, a sum of n number of highest scores from the reordered set of chunks, wherein the sum is at least equal to a threshold, and produce a subset of chunks that are associated with the n number of highest scores;
identifying, using the labelling module, one or more documents, which are associated with the subset of chunks, as relevant to the query, wherein the one or more documents being a subset of the set of documents; and
retrieving, using the retriever module, the one or more documents from a document repository and ignoring a remaining set of documents of the set of documents; and,
generating and outputting, using the generator LLM, a response to the query that comprises text from the one or more documents.
